(19) United States
(12) Patent Application Publication
(10) Pub. No.: US 2008/0074279 A1
(43) Pub. Date: Mar. 27, 2008

(54) ROTATING FLASHING WARNING SIGNAL LAMP

(75) Inventors: Shan-Ching Chiu, Sindian City (TW); Yen-Lan Chiu, Sindian City (TW)

Correspondence Address: IDEALITE OPTOELECTRONICS, INC., P.O. BOX 108-00403, TAIPEI 106, omitted

(73) Assignee: IDEALITE OPTOELECTRONICS INC., Sindian City, Taipei Hsien (TW)

(21) Appl. No.: 11/532,107

(22) Filed: Sep. 15, 2006

(51) Int. Cl. G09F 9/33; G08B 5/24

(52) U.S. Cl. 340/815.45; 340/815.86

(57) ABSTRACT

A rotating flashing warning signal lamp is disclosed to include a housing houses a LED type light source, a reflector, which has an anchoring member for positioning, a flat reflecting panel for reflecting light from the LED type light source, and a friction hinge coupled between the flat reflecting panel and the anchoring member for allowing adjustment of the reflecting angle of the flat reflecting panel, and a power drive, which has a driven member that supports the anchoring member of the reflector, a motor, and a driving member driven by the motor to rotate the driven member, thereby turning the reflector about the LED type light source to produce a flashing warning signal when the LED type light source is turned on.

### BACKGROUND OF THE INVENTION

1. Field of the Invention

The present invention relates to signal lamps and more particularly, to a rotating flashing warning signal lamp, which provides an optimum signaling effect.

2. Description of the Related Art

A rotating flashing warning signal lamp may be used in a fixed place such as construction worksite, dangerous bridge, road, fence, gate, etc., or on a moving object such as ambulance, police car, patrol car, or the like. A rotating flashing warning signal lamp may also be used for advertising or decoration purpose. FIGS. 9 and 10 show a conventional rotating flashing warning signal. According to this design, the rotating flashing warning signal comprises a hollow base A, a gearwheel A1 pivotally mounted in the base A on the middle, a motor and pinion set A2 mounted inside the base A and controllable to rotate the gearwheel A1, an incandescent lamp bulb B1 and a disk reflector B fixedly supported on the gearwheel A1, and a lampshade C covered on the base A over the an incandescent lamp bulb B1 and the disk reflector B. When starting the motor of the motor and pinion set A2, the incandescent lamp bulb B1 and the disk reflector B are turned with the gearwheel A1, proving a flashing warning signal.

The aforesaid conventional rotating flashing warning signal lamp has numerous drawbacks as follows:

1. The incandescent lamp bulb B1 becomes hot quickly during working, and tends to burn out after a long use. Therefore, the maintenance cost of this design of rotating flashing warning signal lamp is high.

2. The incandescent lamp bulb B1 consumes much power supply during working, and therefore, it is necessary to frequently charge or replace the connected external storage battery or dry battery.

3. The disk reflector B is a hollow rounded reflecting member. Light from the incandescent lamp bulb B1 are diffused when reflected by the disk reflector B, and a person looking at the flashing warning signal may feel dizzy.

### SUMMARY OF THE INVENTION

The present invention has been accomplished under the circumstances in view. It is therefore the main object of the present invention to provide a rotating flashing warning signal lamp, which provides an optimum signaling effect without causing the person looking at the flashing warning signal to feel dizzy.

According to one aspect of the present invention, the rotating flashing warning signal lamp comprises a housing, power drive means, and a reflector. The housing has an enclosed space and light source means fixedly mounted in the enclosed space. The power drive means comprises a motor fixedly mounted in the enclosed space inside the housing, a driven member, and a driving member coupled between the motor and the driven member for rotating the driven member when the motor is started. The reflector is adapted to reflect light from the light source means, comprising an anchoring member fixedly fastened to the driven member, a flat reflecting panel, which has at least one planar reflecting surface for reflecting light from the light source means, and a friction hinge coupled between one side of the anchoring member and one side of the flat reflecting panel.

According to another aspect of the present invention, the light source means comprises a circuit board fixedly mounted in the enclosed space inside the housing, and a plurality of LEDs (light emitting diodes) installed in the circuit board by means of a surface mounting technique. Because the light source means uses LEDs to give off light, it does not become hot during working and is durable in use.

According to still another aspect of the present invention, the flat reflecting panel is set at 45° above the upright LEDs of the light source means to reflect vertically extending light rays from the LEDs into horizontally extending light rays, enhancing the signaling effect.

### BRIEF DESCRIPTION OF THE DRAWINGS

FIG. 1 is a perspective view of a rotating flashing warning signal lamp in accordance with a first embodiment of the present invention.

FIG. 2 is an enlarged view of a part of FIG. 1, showing the structure of the power drive.

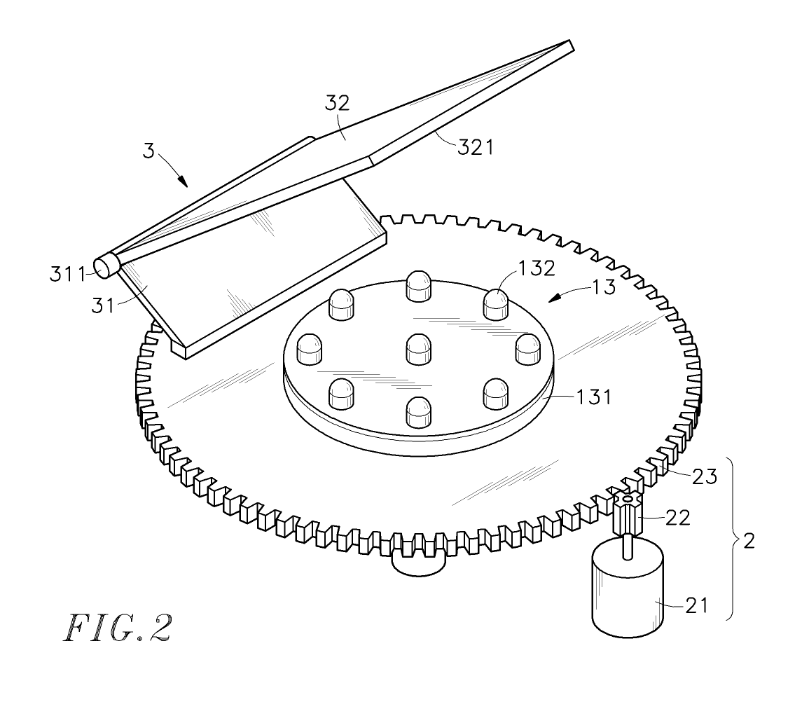

FIG. 3 is a sectional side view of the rotating flashing warning signal lamp in accordance with the first embodiment of the present invention.

FIG. 4 is a schematic drawing showing the reflecting action of the reflector of the rotating flashing warning signal lamp in accordance with the first embodiment of the present invention.

FIG. 5 is a schematic sectional side view of a rotating flashing warning signal lamp in accordance with a second embodiment of the present invention.

FIG. 6 is a schematic sectional side view of a rotating flashing warning signal lamp in accordance with a third embodiment of the present invention.

FIG. 7 is a schematic sectional side view of a rotating flashing warning signal lamp in accordance with a fourth embodiment of the present invention.

FIG. 8 is a schematic sectional side view of a rotating flashing warning signal lamp in accordance with a fifth embodiment of the present invention.

FIG. 9 is an elevational view of a warning signal lamp according to the prior art.

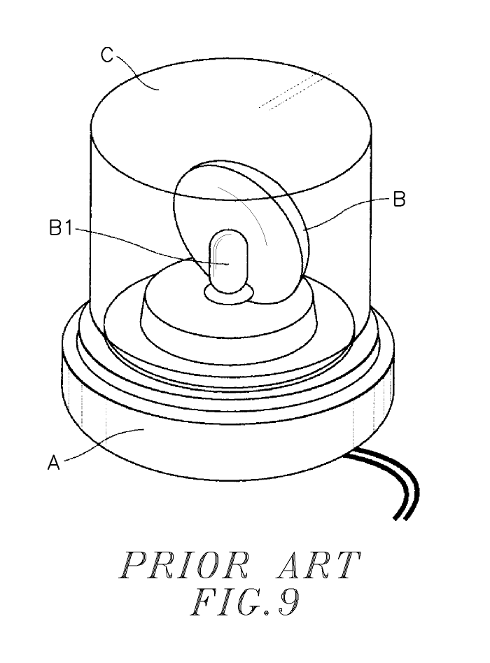

FIG. 10 is a sectional side view of the warning signal lamp according to the prior art.

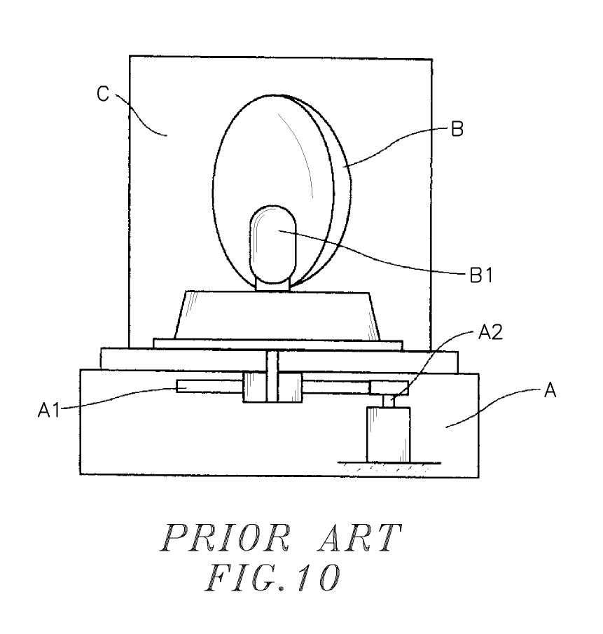

### DETAILED DESCRIPTION OF THE PREFERRED EMBODIMENT

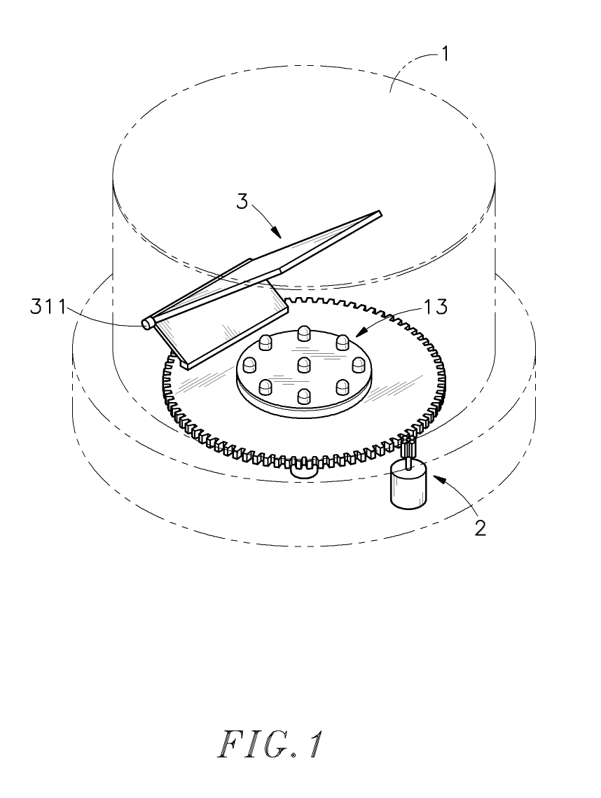

Referring to FIGS. 1˜3, a rotating flashing warning signal lamp in accordance with a first embodiment of the present invention is shown comprising a housing 1, a light source 13, a power drive 2, and a reflector 3.

The housing 1 has an enclosed space 11, and a rack 12 fixedly provided at the bottom side inside the enclosed space 11.

The light source 13 is fixedly mounted on the rack 12 inside the housing 1, comprising a circuit board 131 electrically connected to power supply (storage battery, dry battery, city power supply, etc.) and a plurality of LEDs (light emitting diodes) 132 installed in the circuit board 131.

The power drive 2 comprises a motor 21, a driving member 22, and a driven member 23.

The reflector 3 comprises an anchoring member 31, a flat reflecting panel 32, and a friction hinge 311 coupled between one side of the anchoring member 31 and one side of the reflecting panel 32. The reflecting panel 32 has a planar reflecting surface 321 on one side or each of two opposite sides thereof.

During installation, the motor 21 of the power drive 2 is mounted in the enclosed space 11 inside the housing 1, the driven member 23 is pivoted to the bottom side of the light source 13, the driving member 22 is coupled between the motor 21 and the driven member 23, and the anchoring member 31 of the reflector 3 is affixed to the top side of the driven member 23. According to this embodiment, the driven member 23 is a gearwheel pivoted to the bottom side of the light source 13 in horizontal, and the driving member 22 is a pinion fixedly mounted on the output shaft of the motor 21 and meshed with the gearwheel 23. Alternatively, rack and gear transmission means, belt and belt wheel transmission means, chain and chain wheel transmission means, or any of a variety of transmission means may be used to substitute for the pinion and gearwheel transmission mechanism. After installation, the reflecting panel 32 is turned relative to the anchoring member 31 to the desired angle (for example, 45°), keeping the planar reflecting surface 321 to face the LEDs 132.

The LEDs 132 may be bonded to the circuit board 131 through a surface mounting technique. The light source uses the LEDs 132 to give off light for the advantages of low power consumption, no heat after working, and long service life. Further, the planar reflecting surface 321 of the reflecting panel 32 reflects light from the LEDs 132 in a predetermined direction, thereby lowering loss of luminous intensity and enhancing the light intensity of the LEDs 132, i.e., lowering the number of times in maintaining and replacing the warning signal lamp.

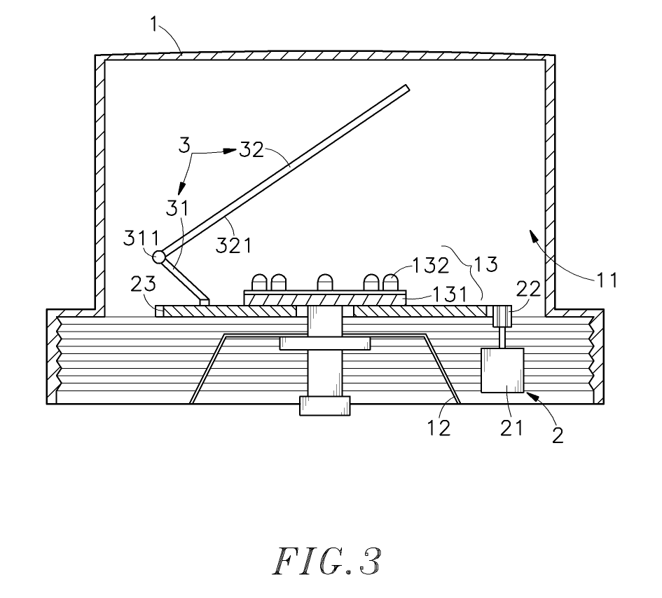

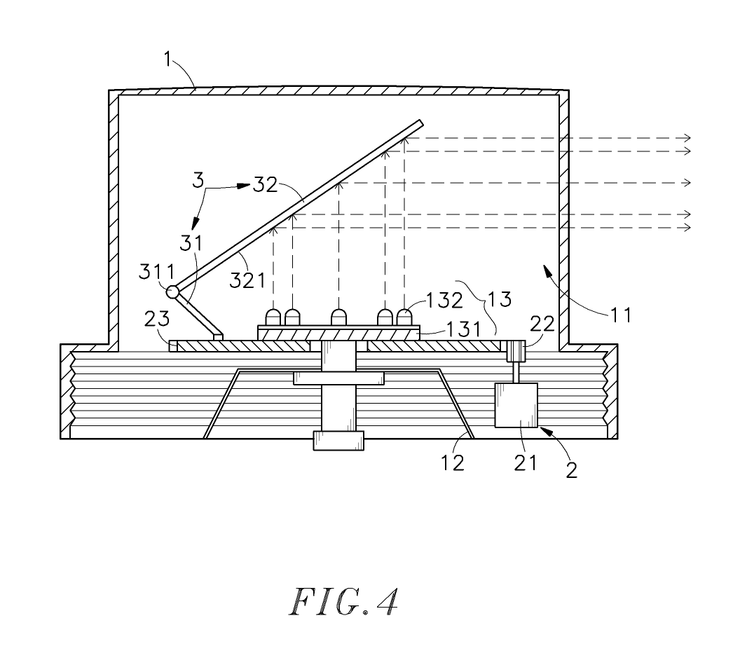

Referring to FIGS. 3 and 4, when in use, power supply is electrically connected to the light source 13, causing the LEDs 132 to give off light. At the same time, the motor 21 of the power drive 2 drives the driving member 22 to rotate the driven member 23, therefore the reflector 3 is turned with the driven member 23 relative to the LEDs 132 and the circuit board 131. Because the planar reflecting surface 321 of the reflecting panel 32 of the reflector 3 reflects light from the LEDs 132, a flashing visual signal is produced during rotation of the reflector 3 with the driven member 23. Further, the reflecting panel 32 is kept at 45° above the LEDs 132 that are installed in the circuit board 131 in vertical. Therefore, the planar reflecting surface 321 of the reflecting panel 32 reflects the vertically extending light rays of the LEDs 132 into horizontally extending light rays to prevent diffusion of light and to lower loss of luminous intensity. Any person looking at the flashing warning signal produced by the rotating flashing warning signal lamp does not feel dizzy. Further, the friction hinge 311 allows the user to adjust the angle of the reflecting panel 32 subject to the amount and location of the LEDs 132. According to this embodiment, the housing 1 houses only one light source 13. Alternatively, two or more light sources may be used.

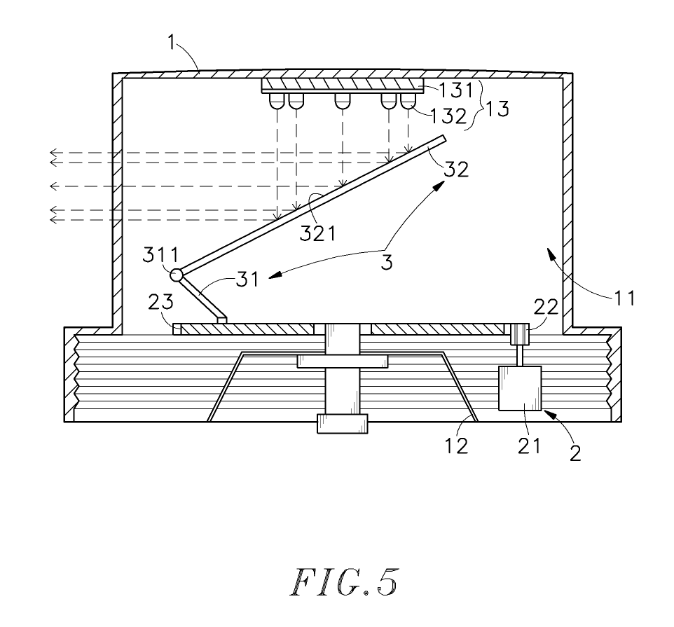

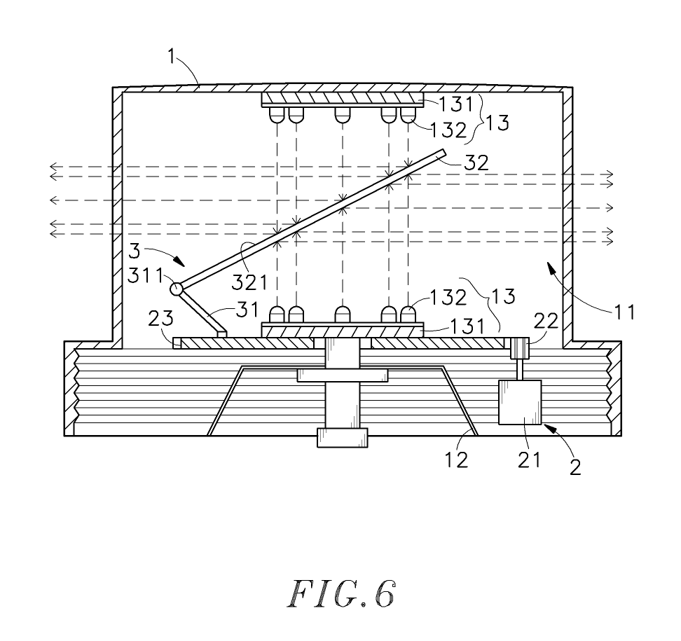

In the aforesaid first embodiment, as shown in FIG. 4, the light source 13 is fixedly mounted on the rack 12, and the reflecting panel 32 of the reflector 3 is kept at 45° above the light source 13. FIG. 5 is a schematic sectional side view of a rotating flashing warning signal lamp in accordance with a second embodiment of the present invention. This embodiment is substantially similar to the aforesaid first embodiment with the exception of the installation position of the light source 13. According to this second embodiment, the light source 13 is affixed to the inner side of the horizontal top wall of the housing 1, and the reflecting panel 32 of the reflector 3 is kept at 45° below the light source 13. FIG. 6 is a schematic sectional side view of a rotating flashing warning signal lamp in accordance with a third embodiment of the present invention. According to this embodiment, two light sources 13 are respectively affixed to the rack 12 and the inner side of the horizontal top wall of the housing 1, and the reflector 3 is kept at 45° between the two light sources 13 with the two opposite planar reflecting surfaces 321 to face the LEDs 132 of the two light sources 13.

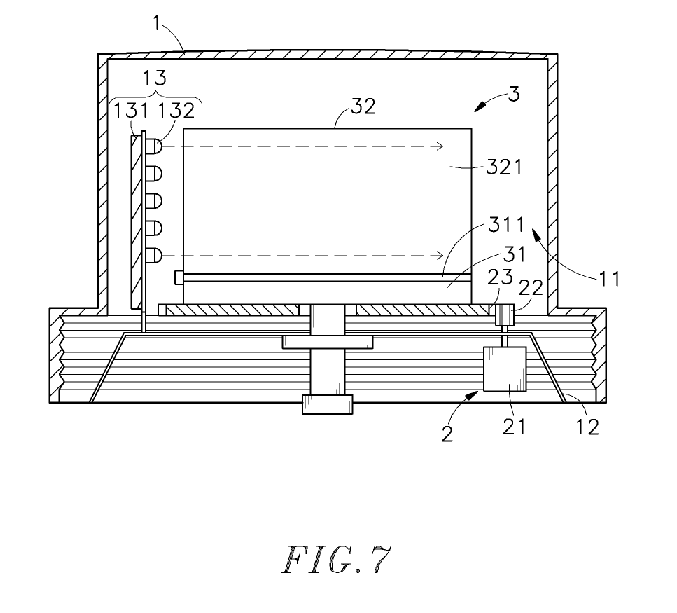

FIG. 7 is a schematic sectional side view of a rotating flashing warning signal lamp in accordance with a fourth embodiment of the present invention. According to this embodiment, the motor 21 of the power drive 2 is fixedly mounted in the enclosed space 11 of the housing 1 at one side; the driven member 23 is horizontally pivotally coupled to the rack 12 inside the enclosed space 11 of the housing 1 and meshed with the driving member 22 at the output shaft of the motor 21; the circuit board 131 of the light source 13 is vertically mounted in the enclosed space 11 of the housing 1 at an opposite side to hold the LEDs 132 in horizontal at different elevations; the reflecting panel 32 of the reflector 3 is kept in vertical with the planar reflecting surface 321 facing the LEDs 132 of the light source 13. This embodiment achieves the same effect as the aforesaid various different embodiments.

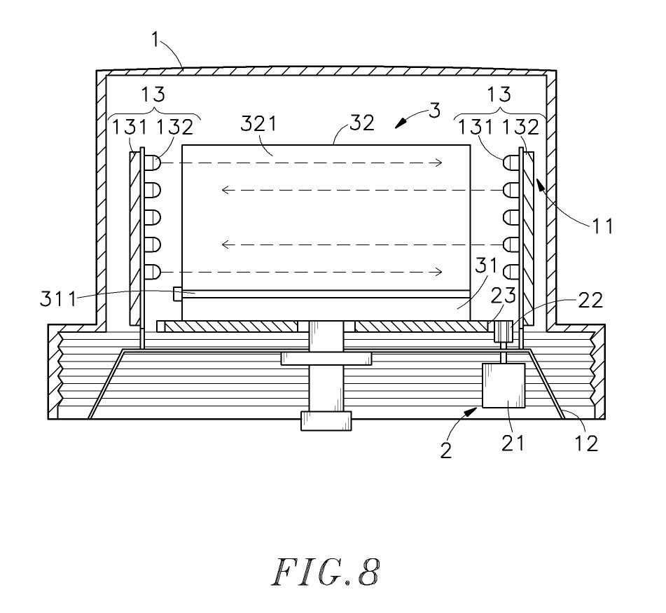

FIG. 8 is a schematic sectional side view of a rotating flashing warning signal lamp in accordance with a fifth embodiment of the present invention. This embodiment is substantially similar to the aforesaid fourth embodiment with the exception that two light sources 13 are vertically mounted in the enclosed space 11 of the housing 1 at two opposite sides.

As stated above, the invention provides a rotating flashing warning signal lamp, which has the following benefits:

1. The light source 13 uses a plurality of LEDs 132 to give off light. Therefore, the rotating flashing warning signal lamp saves much power, has a long service life, will not become hot during working, and does not fail easily, i.e., the rotating flashing warning signal lamp does not require a maintenance work frequently, thereby saving the maintenance cost.

2. The LEDs 132 of the rotating flashing warning signal lamp consume a small amount of power supply. Therefore, it is not necessary to frequently charge or replace the connected external storage battery or dry battery.

3. The reflector 3 has a flat reflecting panel 32 with one or two planar reflecting surfaces 321 to reflect light rays from the light source 13 at right angles, eliminating diffusion of light and enhancing the light intensity.

4. The flat reflecting panel 32 of the reflector 3 can be adjusted relative to the LEDs 132 to the desired angle to reflect light rays from the LEDs 132 toward the desired direction so that the flashing warning signal is clearly visible from distance.

Although particular embodiments of the invention have been described in detail for purposes of illustration, various modifications and enhancements may be made without departing from the spirit and scope of the invention.

What the invention claimed is:

1. A rotating flashing warning signal lamp comprising:
a housing, said housing having an enclosed space and light source means fixedly mounted in said enclosed space;
power drive means, said power drive means comprising a motor, a driven member, and a driving member coupled between said motor and said driven member for rotating said driven member when said motor is started; and
a reflector adapted to reflect light from said light source means, said reflector comprising an anchoring member fixedly fastened to said driven member, a flat reflecting panel, said flat reflecting panel having at least one planar reflecting surface adapted to reflect light from said light source means, and a friction hinge coupled between one side of said anchoring member and one side of said flat reflecting panel.

2. The rotating flashing warning signal lamp as claimed in claim 1, further comprising a rack fixedly mounted in said housing to support said light source means in said enclosed space.

3. The rotating flashing warning signal lamp as claimed in claim 1, wherein said light source means comprises a circuit board and a plurality of light emitting diodes installed in said circuit board.

4. The rotating flashing warning signal lamp as claimed in claim 1, wherein said light source means comprises a first light source and a second light source horizontally arranged at two opposite sides at different elevations in said enclosed space; said flat reflecting panel of said reflector is spaced between said first light source and said second light source, having two planar reflecting surfaces respectively facing said first light source and said second light source.

5. The rotating flashing warning signal lamp as claimed in claim 1, wherein The warning signal lamp as claimed in claim 1, wherein said light source means comprises a first light source and a second light source vertically arranged at two opposite sides at different elevations in said enclosed space; said flat reflecting panel of said reflector is spaced between said first light source and said second light source, having two planar reflecting surfaces respectively facing said first light source and said second light source.

6. The rotating flashing warning signal lamp as claimed in claim 1, wherein said driving member is a pinion fixedly mounted on an output shaft of said motor, and said driven member is a gearwheel pivotally mounted in said enclosed space inside said housing and meshed with said pinion.

7. The rotating flashing warning signal lamp as claimed in claim 1, wherein said driving member is a belt, and said driven member is a belt wheel.

8. The rotating flashing warning signal lamp as claimed in claim 1, wherein said driving member is a chain, and said driven member is a chain wheel.
